(19) United States
(12) Patent Application Publication
(10) Pub. No.: US 2026/0135300 A1
(43) Pub. Date: May 14, 2026

(54) MULTIBAND LOOP ANTENNA WITH EXTENDED BANDWIDTH

(71) Applicant: BSH Hausgeräte GmbH, München (DE)

(72) Inventors: Stefan GAIER, Stuttgart (DE); Matthias LUNGWITZ, Mössingen (DE)

(21) Appl. No.: 19/118,036

(22) PCT Filed: Feb. 26, 2024
(86) PCT No.: PCT/EP2024/054749

§ 371 Date: Apr. 3, 2025

(30) Foreign Application Priority Data
Feb. 28, 2023 (DE) 10 2023 201 834.9

(51) Int. Cl. H01Q 7/00; H01Q 5/335; H01Q 5/378; H01Q 9/42

(52) U.S. Cl. CPC H01Q 7/00; H01Q 5/335; H01Q 9/42; H01Q 5/378

(57) ABSTRACT

A multiband loop antenna includes a first, electrically conductive, L-shaped substructure on a first layer of a printed circuit board. The first substructure has a first resonant frequency and a feed point of the antenna. A second, electrically conductive, L-shaped substructure on the first layer of the printed circuit board is configured for a second resonant frequency. The first and second substructures are capacitively coupled to one another in a coupling region. The first and second substructures are disposed on the first layer of the printed circuit board in such a manner as to form a loop together with an electrically conductive first reference region. An electrically conductive second reference region on an electrically conductive second layer of the printed circuit board has an impedance element which extends away from the second reference region starting from a transverse edge of the second reference region.

The invention relates to a loop antenna for transmitting or receiving radio signals, wherein the loop antenna is implemented on a circuit board.

An electronic device that is configured to communicate via a wireless communication network typically comprises at least one antenna for receiving and/or transmitting radio signals. In this case, the electronic device can be configured so as to receive or transmit radio signals over a large number of different frequency bands, in particular over two different frequency bands or frequency ranges. For this purpose, the device can comprise a multiband antenna, in particular a dual-band antenna. Exemplary dual-band antennas can be provided, for example, for the frequency bands 2.4-2.5 GHz and 5.1-5.8 GHz, i.e. for WLAN (Wireless Local Area Network). In this case, it may be necessary or desired to expand the bandwidth of at least one of the frequency bands in an efficient manner, for example in order to also be able to receive and/or transmit WLAN frequency at 6 GHZ.

Antennas typically require a reference ground or reference plane for their function. The size and shape of such a reference ground typically have a significant influence on the function and emission characteristic of an antenna. An antenna is often to be used as a circuit board structure or as an attached metal structure (e.g. as a stamped and bent part) in circuit boards of different sizes. The differently sized circuit boards represent different reference grounds for an antenna. In addition, plastic in the vicinity of the antenna (for example, due to a housing) can also influence the properties of an antenna. As a result, a new antenna tuning is typically required for each circuit board geometry and/or application. Such an antenna tuning can be effected, for example, by changing the antenna structure.

The present document deals with the technical task of providing a (multiband or dual band) antenna with one or more extended frequency bands, which can be integrated in an efficient manner (in particular without the requirement of a dedicated antenna tuning) on different circuit boards and/or in different environments. In other words, a multiband antenna with at least one extended frequency band is to be provided, which is insensitive to variations in the environment of the antenna.

The object is achieved by the independent claim. Advantageous embodiments are described, inter alia, in the dependent claims.

In accordance with one aspect, a multiband loop antenna is described. In this case, the multiband loop antenna described in this document can be implemented in an efficient manner on differently dimensioned circuit boards and/or in different environments or applications (in particular in different devices). A circuit board typically comprises an electrically conductive first (outer) layer (for example, a front layer) and an electrically conductive second (outer) layer (for example, a lower layer). The one or more layers can be electrically insulated from one another by one or more dielectric layers. The first and second layers can each comprise an electrically conductive material, in particular copper. In this case, the electrically conductive material can be removed at least in regions from the respective layer, in particular in order to form a free space or a gap between an (electrically conductive) antenna structure and an (electrically conductive) reference region.

The multiband loop antenna comprises a first, electrically conductive, L-shaped substructure on the first layer of the circuit board. The first substructure can have a first resonant frequency. In particular, the first substructure can form a first L-antenna for a first frequency range around the first resonant frequency. The first frequency range can comprise, in particular can be, 2.4-2.5 GHZ.

The first substructure has a feed point of the antenna, via which an RF (radio frequency) signal to be transmitted can be fed into the antenna and/or a receiving RF signal can be fed out of the antenna.

Furthermore, the multiband loop antenna comprises a second, electrically conductive, L-shaped substructure on the first layer of the circuit board. In this case, the second substructure can be designed for a second resonant frequency and thus for a second frequency range. The second substructure can form a second L-antenna for the second frequency range around the second resonant frequency. The second frequency range can comprise, in particular can be, 5.18-6.425 GHZ.

The first substructure and the second substructure are capacitively coupled to one another in a coupling region. In this case, the coupling region can be designed in such a manner that an RF signal with a frequency from the second frequency range is transmitted via the coupling region (for example, from the feed point to the second substructure or from the second substructure to the feed point).

The multiband loop antenna further comprises an electrically conductive first reference region, which can be connected to a ground potential, for example. The area of the first reference region is typically significantly larger, in particular by a factor of 5 or more, or 10 or more, than the area of the two substructures.

The first substructure and the second substructure are arranged on the first layer of the circuit board in such a manner that they form a loop or a bow or a frame together with the first reference region. A loop antenna comprising a plurality of substructures can thus be provided in each case for different frequency ranges. In this manner a multiband loop antenna can be provided, which is insensitive to changes in the environment of the antenna, and can thus be installed in different devices in a flexible manner.

The second substructure can be connected in an electrically conductive manner to the first reference region, and in particular can be designed as a parasitic element of the multiband loop antenna.

On the other hand, an electrically insulating gap or free space can be arranged between the first substructure and the first reference region. The feed point can then be arranged at the end of the first substructure that faces the gap or free space. In this manner, a multiband loop antenna can be provided in a particularly efficient and compact manner. In particular, it can thus be made possible to transmit the RF signals for a plurality of different frequency bands, in particular for the first and the second frequency band, via a single feed point.

The first substructure can have a first limb and a second limb, which together form the L-shape. The first limb can be shorter than the second limb. The first limb of the first substructure can extend away from the first reference region, in particular perpendicularly, along a longitudinal axis (or along a y axis of a Cartesian coordinate system).

In a corresponding manner, the second substructure can have a first limb and a second limb, which together form an L-shape. The first limb can be shorter than the second limb. The first limb of the second substructure can extend away from the first reference region, in particular perpendicularly, along the longitudinal axis.

The second limb of the first substructure can extend, in particular perpendicularly to the first limb of the first substructure, along a transverse axis (or along an x axis of the Cartesian coordinate system) toward the second substructure. In a corresponding manner, the second limb of the second substructure can extend toward the first substructure along the transverse axis, in particular perpendicular to the first limb of the second substructure. In this case, the second limbs of the two substructures can run parallel to one another.

The first L-shaped substructure and the second L-shaped substructure can thus be arranged in relation to one another in such a manner that they have a U-shape together. In this manner, a multiband loop antenna can be provided in a particularly efficient and compact manner.

The second limb of the first substructure can adjoin the second limb of the second substructure in the coupling region. In addition, the second limb of the first substructure and the second limb of the second substructure can run parallel to one another, in particular in the coupling region. In addition, a part of the second limb of the first substructure and a part of the second limb of the second substructure can run directly next to one another in the coupling region and can be spaced apart from one another by an electrically insulating coupling gap.

In a preferred example, the part of the second limb of the first substructure and the part of the second limb of the second substructure, which run directly next to one another in the coupling region, in each case correspond to less than 50%, in particular less than 30%, of the limb length of the respective second limb, and/or in each case more than 10% of the limb length of the respective second limb. In this manner, a particularly reliable capacitive coupling can be formed between the substructures.

Parts of the second limbs of the two substructures can thus together form a capacitor for a capacitive coupling of the two substructures in order to provide a multiband loop antenna in an efficient and compact manner.

The first limb of the first substructure and the first limb of the second substructure can each run (along the longitudinal axis) toward a specific edge of the circuit board. In this case, the antenna can be designed in such a manner that the second limb of the first substructure is arranged closer to the edge of the circuit board in the coupling region than the second limb of the second substructure. In particular, a part of the second limb of the second substructure can be shielded from the edge of the circuit board by a part of the second limb of the first substructure. The second substructure can thus be arranged at a relatively large distance from the edge of the circuit board. In this manner, the sensitivity of the antenna can be further reduced, in particular if the second substructure is designed for a (second) frequency range having higher frequencies than the first substructure.

The first and/or the second substructure can have a width that is increased with respect to the limb width of the limbs in a transition region between the limbs of the respective substructure (in particular at the point at which the two limbs are connected to one another). By increasing the width of a substructure in the transition region, the bandwidth of the frequency range of the respective substructure can be increased.

The limbs of the first substructure can have a total length that depends on the first resonant frequency. In particular, the first substructure can be designed as a λ/4 emitter in relation to the first resonant frequency.

The limbs of the second substructure can have a total length that depends on the second resonant frequency. In particular, the second resonant frequency (to be caused) can depend on the total length of the limbs of the second substructure and can depend on at least one property, in particular on the capacitance, of the coupling region between the first substructure and the second substructure.

The different frequency ranges of the multiband loop antenna can thus be defined in a precise manner by the total length of the limbs and/or by the design of the coupling region.

As already explained above, the multiband loop antenna has an electrically conductive second layer of the circuit board. In particular, the multiband loop antenna has an electrically conductive second reference region on the second layer of the circuit board (wherein the second reference region can be at ground potential). The second reference region and the first reference region can be arranged at least in regions or completely overlapping one another (for example, except for a recessed region of the first reference region). The second reference region on the second layer can be connected in an electrically conductive manner to the first reference region on the first layer via one or more plated-through holes (i.e. electrical lines). By providing a second reference region, the sensitivity of the multiband loop antenna to changes in the environment can be further reduced.

The second reference region has a transverse edge that extends along the transverse axis (for example, over the entire expansion of the antenna along the transverse axis). Furthermore, the second reference region has an impedance element that extends away from the transverse edge of the second reference region along the longitudinal axis, starting from the transverse edge of the second reference region. The impedance element can be designed, for example, in the form of a rectangle, in particular as a rectangular, electrically conductive surface.

The impedance element can be arranged on the second layer of the circuit board 31 in such a manner that the impedance element is encompassed (if appropriate completely) by the loop (on the first layer of the circuit board). The loop that is arranged on the first layer of the circuit board can encompass an electrically non-conductive free area on the first layer of the circuit board. The entire impedance element or a subregion of the impedance element can be arranged on the second layer of the circuit board opposite the electrically non-conductive free area on the first layer of the circuit board and/or can be arranged facing the electrically non-conductive free area on the first layer. In other words, the entire impedance element or a subregion of the impedance element can be arranged on the second layer of the circuit board where the first layer of the circuit board has the electrically non-conductive free surface that is encompassed (if appropriate completely) by the loop.

The impedance element can preferably extend along the longitudinal axis and/or the transverse axis in such a manner that no subregion of the impedance element is arranged on the second layer opposite the second substructure and/or opposite the first reference region on the first layer and/or opposite the first limb of the first substructure.

The impedance element can be arranged (on the second layer) and/or can be encompassed by the loop (on the first layer) in such a manner that
the impedance element has an overlap with the first substructure, in particular with the first limb of the first substructure;
has no overlap with the second limb of the first substructure and/or is spaced apart from the second limb of the first substructure along the longitudinal and/or transverse axis; and/or
has no overlap with the second substructure and/or is spaced apart from the second substructure along the longitudinal and/or transverse axis; and/or
has no overlap with the first reference region on the first layer and/or is spaced apart from the first reference region on the first layer along the longitudinal and/or transverse axis.

A multiband loop antenna is thus described, which has an additional impedance 31 element, due to which the bandwidth of the impedance of the antenna at the feed point for the second frequency range can be increased in an efficient and reliable manner in order to provide a multiband loop antenna with an extended second frequency range.

The first reference region likewise can have a transverse edge that extends along the transverse axis. The first limb of the second substructure can be coupled in an electrically conductive manner to the first reference region at this transverse edge of the first reference region, and can extend away from this transverse edge of the first reference region along the longitudinal axis.

The transverse edge of the first reference region and the transverse edge of the second reference region can run parallel to one another. In this case, the distance between the transverse edge of the first reference region and the transverse edge of the second reference region (outside an optional recessed region of the first reference region) can correspond to the perpendicular distance between the first layer and the second layer (along the z axis of the Cartesian coordinate system) and/or exceed the perpendicular distance between the first layer and the second layer by at most 10%. In other words, the transverse edges of the two reference regions can be arranged directly one above the other (at least in regions) on different layers of the circuit board. In this manner, a multiband loop antenna can be provided, which can be used in a particularly flexible manner in different environments.

The first reference region can have a recessed region, in particular a rectangular recessed region, in which the transverse edge of the first reference region is arranged offset from the transverse edge of the second reference region along the longitudinal axis. The offset along the longitudinal axis can be 10% or more and/or 70% or less of the length of the first limb of the first substructure along the longitudinal axis.

The feed point of the antenna in the recessed region can adjoin the transverse edge of the first reference region. Furthermore, the first limb of the first substructure can extend away from the transverse edge of the first reference region in the recessed region.

The recessed region of the first reference region can have a width along the transverse axis that is so large that the recessed region is wider than the first limb of the first substructure, which extends along the longitudinal axis. Alternatively or additionally, the recessed region of the first reference region can have a width along the transverse axis that is so small that the second limb of the first substructure, which extends along the transverse axis, extends beyond the recessed region of the first reference region along the transverse axis.

Preferably, the second reference region does not have a corresponding recessed region, so that the second reference region in the recessed region of the first reference region covers a subregion of the electrically non-conductive free area that is encompassed by the loop on the first layer of the circuit board.

By providing a recessed region of the first reference region, the frequency selectivity of the multiband loop antenna can be further improved.

The impedance element can adjoin, in particular completely or partially, the transverse edge of the second reference region in the recessed region of the first reference region and extends away from the transverse edge of the second reference region along the longitudinal axis. In this manner, it is possible to cause a particularly precise adjustment of the bandwidth of the second frequency range.

As already explained above, the first substructure can have a transition region in a transition between the first limb and the second limb of the first substructure, in which the width of the first limb (along the transverse axis) increases smoothly, in particular linearly, from a first width to a second width. The second width can be greater than the first width, for example, by a factor of 1.2 to 2.

The transition region can begin at a first distance along the longitudinal axis from the transverse edge of the second reference region and can end at a second distance along the longitudinal axis from the transverse edge of the second reference region in the second limb of the first substructure. By providing such a transition region, the bandwidth of the first frequency range can be adjusted (in particular widened).

The impedance element can extend along the longitudinal axis in such a manner that the transverse edge of the impedance element, which faces away from the second reference region, is arranged at a distance from the transverse edge of the second reference region that lies between the first distance and the second distance. Alternatively or additionally, the impedance element can have an overlap along the transverse axis of the first limb of the first substructure. The overlap is preferably greater than zero. In addition, the overlap can be the same as or smaller than the first width (of the first limb of the first substructure). An impedance element that is designed and/or arranged in this manner can be used to cause a particularly precise impedance matching to the desired second frequency range.

The impedance element can have a width along the transverse axis that is equal to or greater than the (first) width of the first limb of the first substructure, and/or that is less than twice the width of the first limb of the first substructure. An impedance element that is designed and/or arranged in this manner can be used to cause a particularly precise impedance matching to the desired second frequency range.

In accordance with a further aspect, an electrical appliance, in particular a household appliance, is described, which comprises a communication unit for wireless communication (in particular via WLAN), wherein the communication unit has the multiband loop antenna described in this document.

It should be noted that the apparatuses and systems described in this document can be used both alone and in combination with other apparatuses and systems described in this document. Furthermore, any aspects of the apparatuses and systems described in this document can be combined with one another in a variety of ways. In particular, the features of the claims can be combined with one another in a variety of ways.

The invention is further described below with reference to exemplary embodiments. In the drawings:

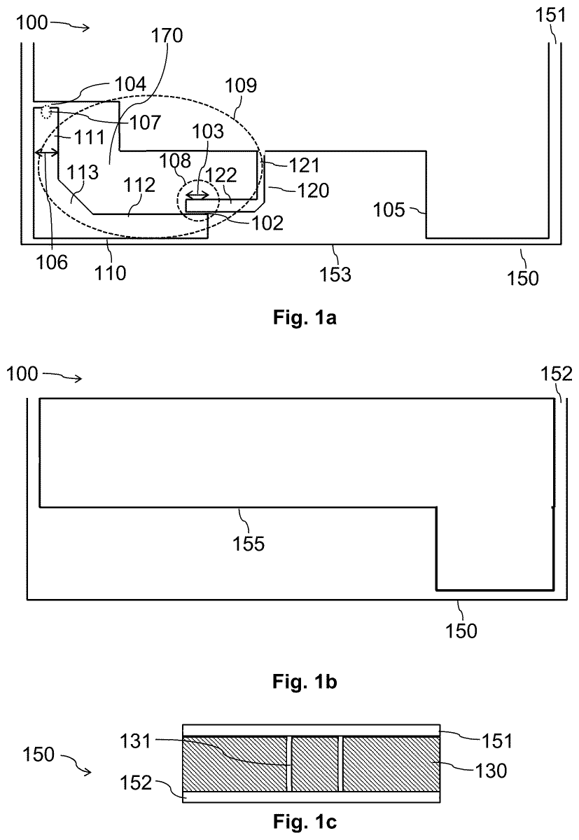

FIG. 1a shows the upper or the first outer layer of a circuit board having an antenna;

FIG. 1b shows the lower layer or the second outer layer of a circuit board;

FIG. 1c shows a cross section through a circuit board having an antenna; and

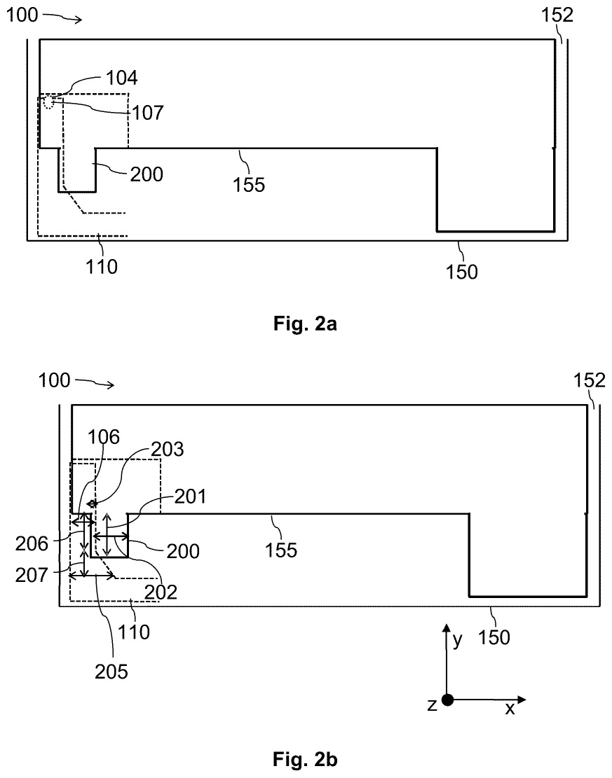

FIGS. 2a and 2b show an antenna having a lower and second outer layer, respectively, which has an additional impedance element.

As explained at the beginning, the present document deals with the provision of a (dual-band) antenna, which can be integrated in an efficient manner on differently dimensioned and/or designed circuit boards and/or in different environments and which has at least one extended frequency band. The (dual-band) antenna is to be designed in particular for WLAN (Wireless Local Area Network) radio communication in the frequency bands at 2.4 GHz and at 5 GHZ and in the additional frequency band at 6 GHZ.

FIGS. 1a and 1b illustrate an exemplary antenna 100 that is integrated on a circuit board 150. In particular, FIG. 1a illustrates the (electrically conductive) upper layer 151 of the circuit board 150 and FIG. 1b illustrates the (electrically conductive) lower layer 152 of the circuit board. As is illustrated in FIG. 1c, one or more dielectric layers 130 and, if appropriate, one or more (electrically conductive) intermediate layers (not shown) are located between the upper (i.e. the first) layer 151 and the lower (i.e. the second) layer 152. The electrically conductive layers 151, 152 can have a layer of metal, in particular copper. The metal can be removed (e.g. etched away) in subregions of the layers 151, 152 in order to form different electrically conductive subregions within a layer 151, 152, wherein the subregions are typically electrically insulated from one another.

The upper layer 151 has an electrically conductive antenna structure, which forms a magnetic antenna or a loop antenna. The antenna structure has a first (L-shaped) substructure 110, which is designed as an antenna for a first frequency or for a first frequency range (approximately 2.4-2.5 GHZ). For this purpose, the limbs 111, 112 of the first L-shaped substructure 110 can together have a certain total length in order to form a λ/4 emitter for the first frequency range.

The antenna structure also has a second (L-shaped) substructure 120, which is designed as an antenna for a second frequency or for a second frequency range (approximately 5.1-6.5 GHz). For this purpose, the limbs 121, 122 of the second L-shaped substructure 120 can together have a certain total length in order to form a λ/4 emitter for the second frequency range (if appropriate in combination with a property, in particular the capacitance, of the coupling region 108 between the two substructures 110, 120).

The two L-shaped substructures 110, 120 are arranged on the upper layer 151 of the circuit board 150 in such a manner that the substructures 110, 120 form a loop or a bow 109 together with a reference region 105 on the upper layer 151. In particular, the first limb 111 of the first substructure 110 can extend away from the reference region 105. The second limb 112 of the first substructure 110 can then run perpendicular to the first limb 111 of the first substructure 110 (and thus parallel to the reference region 105). In a corresponding manner, the first limb 121 of the second substructure 120 can extend away from the reference region 105. The second limb 122 of the second substructure 120 can then extend perpendicularly to the first limb 121 of the second substructure 120 (and thus parallel to the reference region 105).

The second limbs 112, 122 of the two substructures 110, 120 can run parallel to one another in the coupling region 108, wherein a coupling gap 102 is located between the second limbs 112, 122 of the two substructures 110, 120. The gap width of the gap 102 and/or the length 103 of the overlap of the second limbs 112, 122 of the two substructures 110, 120 can be selected in order to provide an optimized compromise between the strongest possible capacitive coupling of the two substructures 110, 120 on the one hand and the strongest possible selectivity and/or delimitation of the two frequency ranges on the other. Alternatively or additionally, the gap width and/or the length 103 of the gap 102 can be selected or defined for adjusting the second resonant frequency for the second frequency range.

The first limb 121 of the second substructure 120 is electrically conductively connected to the reference region 105. On the other hand, an electrically non-conductive gap 104 is arranged between the first limb 111 of the first substructure 110 and the reference region 105. At this point of the first limb 111 of the first substructure 110, a signal to be transmitted can be fed in or a received signal can be fed out. In other words, this point of the first limb 111 of the first substructure 110 can form the feed point 107 of the antenna 100.

The frequency selectivity of the respective frequency range can be adjusted or adapted by the limb width 106 of the limbs 111, 112, 121, 122 of the substructures 110, 120. In this case, the bandwidth of a frequency range can typically be reduced by reducing the limb width 106, while the bandwidth of the frequency range can be increased by increasing the limb width 106.

Alternatively or additionally, an (electrically conductive) transition region 113 that is widened (in comparison with the limb width 106) can be arranged at the transition between the two limbs 111, 112 of a substructure 110. By using a transition region 113 having an increased width, the bandwidth of the frequency range can be increased.

The antenna 100 can have a reference region 155 on the lower layer 152 of the circuit board 150, which can be arranged directly opposite the reference region 105 of the upper layer 151. The two reference regions 105, 155 can be electrically conductively connected to one another via electrically conductive vias or plated-through holes 131.

An antenna 100 is thus described in conjunction with FIGS. 1a and 1b, which has L antennas as substructures 110, 120. An L antenna is an antenna in the form of the letter “L”. By interleaving two L antennas 110, 120, it is possible to form (together with the reference region 105) a loop antenna that has two resonant frequencies. The capacitive coupling between the two L antennas 110, 120 in the coupling region 108 makes it possible to adjust the second resonant frequency of the antenna 100 (for the second frequency range).

The position of the parasitic element (i.e. the second subregion or the second L antenna 120) for the higher (second) frequency range, which is electrically conductively connected to the ground surface (i.e. to the reference region) 105, can be selected such that the parasitic element is as far away as possible from the edge 153 of the circuit board 150. In this manner, it can be achieved that changes in the environment of the antenna 100 (for example, installation of the antenna 100 in a device with or without a plastic housing) change the properties of the resonant frequency (for the second frequency range) as little as possible.

In addition, the first L-antenna 110 can be designed to be wider for the lower (first) frequency range in the bend of the “L” in order to ensure a greater bandwidth in the first frequency range.

FIGS. 2a and 2b each illustrate a second (lower) layer 152 having a reference region 150, which has an additional impedance element 200 for adapting the impedance of the antenna 100 to the feed point 107. The impedance element 200 can in particular be designed so as to adapt the impedance at the feed point 107 in such a manner that signals having a signal frequency in an extended second frequency range (for example in the extended frequency range 5.18 GHZ to 6.425 GHz) can be fed into the antenna 100 or can be coupled out of the antenna 100.

The impedance element 200 can be arranged in the immediate vicinity of the first limb 111 of the first substructure 110 of the antenna 100, so that a parasitic capacitance is formed at the feed point 107 by the impedance element 200. In this case, the impedance element 200 can be arranged completely or partially within the electrically non-conductive free area 170 that is bordered by the loops 109 on the first layer 151 of the circuit board 150 (see FIG. 1a).

FIG. 2b illustrates a Cartesian coordinate system and exemplary dimensions of a part of the first layer 151 (illustrated by dashed lines) and of the entire second layer 152 (illustrated by continuous lines). The first limb 111 of the first substructure 110 extends along the y axis (which is also referred to as the longitudinal axis), and the second limb 112 of the first substructure 110 extends along the x axis (which is also referred to as the transverse axis). The z-axis extends perpendicularly with respect to the surface of the circuit board 150.

The first limb 111 of the first substructure 110 has a specific (first) width 106 (along the x axis). The first limb 111 of the first substructure 110 has this (first) width 106 starting from the gap 104 to the beginning of the transition region 113. A part of this subregion of the first limb 111 extends over a certain length 206, starting from the transverse edge of the second reference region 155.

The transition region 113 thus begins at a distance from the transverse edge of the second reference region 155 that corresponds to the length 206 of a part of the first limb 111. In addition, the transition region 113 has a specific length 207 along the y axis before the first limb 111 merges into the second limb 112. At this point, the transition region 113 has the (second) width 205 (along the x axis), wherein the (second) width 205 is greater than the (first) width 106.

The impedance element 200 preferably has an overlap 203 with the first limb 111. The overlap 203 can be varied and/or adjusted in order to adjust the parasitic capacitance and thus the impedance at the feed point 107. The impedance element 200 can have such a large width 202 (along the x axis) that the sum of the width 106 of the first substructure 111 and the width 202 of the impedance element 200 (minus the overlap 203) is greater than the maximum (second) width 205 of the transition region 113. In this manner, the desired impedance matching at the feed point 107 can be caused in a particularly efficient and reliable manner in order to provide an antenna 100 with an extended second frequency range.

In addition, the impedance element 200 preferably has a length 201 (along the y axis) that is greater than the length 206 of the part of the first limb 111 having a constant width 106, but which, on the other hand, is smaller than the sum of the lengths 206 and 207), so that the end of the impedance element 200 that is facing away from the reference region 155 is arranged along the y axis at the level of the transition region 113. In this manner, the desired impedance matching at the feed point 107 can be caused in a particularly efficient and reliable manner in order to provide an antenna 100 with an extended second frequency range.

As illustrated above, in conjunction with FIGS. 1a to 1c, a dual-band antenna 100 is provided for the WLAN standard Wifi6 (IEEE 802.11ax) and predecessors. The WLAN standard has been extended by additional channels in the frequency range of 6 GHz and higher, above the previous channels with frequencies of less than 6 GHz. An antenna 100 is described in conjunction with FIGS. 2a and 2b, which is designed for such an extension of the upper frequency range.

An additional capacitance can be generated by the addition of a metal surface 200 (in particular a copper surface) with ground potential on the lower circuit board layer 152 directly in the vicinity of the base point 107 of the antenna 100. With this parasitic element 200, it is possible to increase the bandwidth of the impedance in the second (higher) frequency range of the antenna 100. By suitably positioning this additional metal surface 200 on the lower layer 152, the second frequency range of the antenna 100 can be arranged, in particular centered, in relation to the desired frequency range 5.18-6.425 GHz.

Possible variations in the environment of the antenna 100 (with or without plastic) can be mitigated by the antenna 100 described in this document, and the input impedance of the antenna 100 can be caused to be almost independent of the environmental conditions of the antenna 100. In addition, the described antenna 100 has a relatively small space requirement. In addition, by providing an additional impedance element 200, the bandwidth of the second frequency range can be expanded in an efficient and precise manner without impairing and/or changing the efficiency and/or the shape of the antenna diagram of the antenna 100 (in comparison to an antenna 100 with the previous frequency range (5.18-5.825 GHZ)).

The present invention is not limited to the illustrated exemplary embodiments. In particular, it should be noted that the description and the figures are intended to illustrate only the principle of the proposed apparatuses and systems.

1-15. (canceled)

16. A multiband loop antenna, comprising:
a circuit board having a first layer and an electrically conductive second layer;
a first, electrically conductive, L-shaped substructure disposed on said first layer, said first substructure configured for a first resonant frequency, and said first substructure having a feed point of the antenna;
a second, electrically conductive, L-shaped substructure disposed on said first layer, said second substructure configured for a second resonant frequency;
a coupling region, said first substructure and said second substructure being capacitively coupled to one another in said coupling region;
an electrically conductive first reference region;
said first substructure and said second substructure being disposed on said first layer in such a manner as to form a loop together with said first reference region;
said first substructure and said second substructure each having a respective limb extending away from said first reference region along a longitudinal axis and each having a respective limb extending along a transverse axis; and
an electrically conductive second reference region disposed on said second layer, said second reference region having a transverse edge extending along said transverse axis, and said second reference region having an impedance element extending away from said transverse edge of said second reference region along said longitudinal axis, starting from said transverse edge of said second reference region.

17. The multiband loop antenna according to claim 16, wherein:
said loop disposed on said first layer of said circuit board encompasses an electrically non-conductive free area on said first layer of said circuit board; and
said impedance element is disposed on said second layer of said circuit board at least one of opposite said electrically non-conductive free area on said first layer of said circuit board or facing said electrically non-conductive free area on said first layer.

18. The multiband loop antenna according to claim 16, wherein:
said first reference region has a transverse edge extending along said transverse axis;
said limb of said second substructure is coupled in an electrically conductive manner to said first reference region at said transverse edge of said first reference region, and said limb of said second substructure extends away from said transverse edge of said first reference region along said longitudinal axis;
said transverse edge of said first reference region and said transverse edge of said second reference region run parallel to one another; and
said transverse edge of said first reference region and said transverse edge of said second reference region define a distance therebetween at least one of corresponding to a perpendicular distance between said first layer and said second layer or exceeding said perpendicular distance between said first layer and said second layer by at most 10%.

19. The multiband loop antenna according to claim 18, wherein:
said first reference region has a recessed region;
said transverse edge of said first reference region is disposed in said recessed region offset from said transverse edge of said second reference region along said longitudinal axis;
said feed point of the antenna in said recessed region adjoins said transverse edge of said first reference region; and
said impedance element at least partially adjoins said transverse edge of said second reference region in said recessed region of said first reference region and extends away from said transverse edge of said second reference region along said longitudinal axis.

20. The multiband loop antenna according to claim 19, wherein said recessed region has a rectangular shape.

21. The multiband loop antenna according to claim 19, wherein:
said limbs include first and second limbs of said first substructure and first and second limbs of said second substructures;
said recessed region of said first reference region has a width along said transverse axis, said width being at least one of:
so large that said recessed region is wider than said first limb of said first substructure extending along said longitudinal axis, or
so small that said second limb of said first substructure extending along said transverse axis, extends beyond said recessed region of said first reference region along said transverse axis.

22. The multiband loop antenna according to claim 16, wherein said impedance element is rectangular.

23. The multiband loop antenna according to claim 16, wherein:
said limbs include first and second limbs of said first substructure and first and second limbs of said second substructures;
said impedance element is encompassed by said loop in such a manner that:
said impedance element has an overlap with said first substructure or with said first limb of said first substructure; and
said impedance element has:
at least one of no overlap with said second limb of said first substructure or is spaced apart from said second limb of said first substructure along at least one of said longitudinal axis or said transverse axis, or
at least one of no overlap with said second substructure or is spaced apart from said second substructure along at least one of said longitudinal axis or said transverse axis, or
at least one of no overlap with said first reference region on said first layer or is spaced apart from said first reference region on said first layer along at least one of said longitudinal axis said transverse axis.

24. The multiband loop antenna according to claim 16, wherein said impedance element extends along at least one of said longitudinal axis or said transverse axis in such a manner that no subregion of said impedance element is disposed on said second layer at least one of opposite said second substructure or opposite said first reference region on said first layer.

25. The multiband loop antenna according to claim 16, wherein:
said limbs include first and second limbs of said first substructure and first and second limbs of said second substructures;
said first limb of said first substructure extends away from said first reference region or extends perpendicularly away from said first reference region, along said longitudinal axis;
said first limb of said second substructure extends away from said first reference region or extends perpendicularly away from said first reference region, along said longitudinal axis;
said second limb of said first substructure extends relative to said first limb of said first substructure or extends perpendicularly relative to said first limb of said first substructure, along said transverse axis towards said second substructure; and
said second limb of said second substructure extends toward said first substructure along said transverse axis or extends perpendicular to said first limb of said second substructure.

26. The multiband loop antenna according to claim 25, wherein:
said first substructure has a transition region between said first limb and said second limb of said first substructure, and said first limb of said first substructure has a width increasing smoothly or linearly from a first width to a second width; and
said transition region begins at a first distance along said longitudinal axis from said transverse edge of said second reference region and ends at a second distance along said longitudinal axis from said transverse edge of said second reference region in said second limb of said first substructure.

27. The multiband loop antenna according to claim 26, wherein said impedance element at least one of:
extends along said longitudinal axis in such a manner that a transverse edge of said impedance element, facing away from said second reference region, is disposed at a distance from said transverse edge of said second reference region lying between said first distance and said second distance, or
has an overlap along said transverse axis with said first limb of said first substructure.

28. The multiband loop antenna according to claim 16, wherein:
said limbs include first and second limbs of said first substructure and first and second limbs of said second substructures; and
said impedance element has a width along said transverse axis, said width being at least one of:
equal to or greater than a width of said first limb of said first substructure extending along said longitudinal axis, or
less than twice said width of said first limb of said first substructure.

29. The multiband loop antenna according to claim 16, wherein:
said second substructure is connected in an electrically conductive manner to said first reference region;
said first substructure and said first reference region have an electrically insulating gap therebetween; and
said feed point is disposed at an end of said first substructure facing said gap between said first substructure and said first reference region.

30. The multiband loop antenna according to claim 16, wherein:
said first substructure forms a first L-antenna for a first frequency range around a first resonant frequency;
said second substructure forms a second L-antenna for a second frequency range around a second resonant frequency; and
said first frequency range includes or is 2.4-2.5 GHZ and said second frequency range is 5.18-6.425 GHZ.

31. A household appliance, comprising a communication unit having a multiband loop antenna according to claim 16.
